(19) United States
(12) Patent Application Publication
(10) Pub. No.: US 2010/0093238 A1
(43) Pub. Date: Apr. 15, 2010

(54) DEVICE FOR CAMOUFLAGING OBJECTS AND/OR PERSONS

(76) Inventor: Rene Schwarz, Bonstetten (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/442,200

(22) PCT Filed: Sep. 14, 2007
(86) PCT No.: PCT/EP07/59704

§ 371 Date: Nov. 3, 2009

(30) Foreign Application Priority Data
Sep. 23, 2006 (EP) 06019947.8

(51) Int. Cl. B32B 27/12; B32B 5/02; B32B 5/26; B05D 1/02; B05D 3/12; B05D 1/18

(52) U.S. Cl. 442/116; 442/110; 442/239; 442/181; 442/318; 427/427.6; 427/358; 427/430.1

(57) ABSTRACT

A knitted or woven material is proposed for camouflaging objects or persons, having a coating that comprises or has at least one conductive polymer (ICP). Suitable substances for the coating are conductive polymers, for example based on polythiophene (PEDOT).

### RELATED APPLICATION

This is a U.S. national phase application under 35 U.S.C. §371 of International Application No. PCT/EP2007/059704 filed Sep. 14, 2007 with claiming priority of European Application No. EP 06019947.8 filed Sep. 23, 2006.

### TECHNICAL FIELD

The present invention relates to a device for camouflaging objects and/or persons, and to a method for its production.

### BACKGROUND AND SUMMARY

Camouflaging objects is becoming more and more difficult because of the use of more recent technologies, such as radar, infrared night vision devices, and the like, so that conventional camouflage nets, camouflage suits, and the like offer hardly any protection against recognition any more. It is true that measures are known to prevent radar recognition, in particular, such as coating camouflage nets or objects to be camouflaged with a coating based on metallic fillers, such as on the basis of metallic powders or metallic fibers, or on the basis of ferrite, such as carbonyl iron ferrite.

Coatings based on ferrite, in particular, have the disadvantage that they are relatively heavy, and the coating process is not without problems. Individual coloring is also not always possible, because of the filler based on iron.

In EP 1703247, a radar-shielding textile material is described, which has at least two plies and also has a spacer layer. The proposed woven fabric is relatively complicated, particularly in its production, and also relatively heavy.

It is therefore a task of the present invention to propose a measure for camouflaging objects and/or persons to prevent recognition.

According to the invention, a device is characterized by a knitted or woven fabric that is provided with a coating, having or containing at least one inherently conductive polymer (referred to as ICP). It has been shown that surprisingly, coatings based on what are called ICP polymers, which have recently become known, can be used to achieve a similar effect as when using conventional polymers that contain metal fibers or metal powder as fillers.

In other words, it is proposed, according to the invention, to provide a knitted or woven fabric, such as that in general use for camouflage purposes at present, with a coating based on an ICP, such as, in particular, based on polythiophenes.

Possible ICPs are polymers based on polyaniline, polypyrrole, or polythiophenes; these conductive polymers are generally available on the market on the basis of solutions or dispersions. These polymers, i.e. solutions or dispersions of them, are offered for sale by Ormecon GmbH in Ammersbeck; Panipol, Finland; DSM, Holland; BASF AG, Ludwigshafen, and H.C. Starck GmbH, Leverkusen, among others, to mention only a few.

Woven or knitted textiles, such as those on the basis of polyesters, polyamide, aramid (aromatic polyamides), as well as polypropylene, or mixed woven fabrics made of the aforementioned materials, can be used as camouflage materials.

The proposed camouflage material is based on a knitted fabric or an open woven fabric. For shielding against radar ranges of 8 to 12 GHz, metal threads, such as those based on constantan or silver, for example, can be worked into the textile at intervals of approximately 3 to 5 mm, horizontally and vertically, i.e. as warp and weft threads.

To increase the shielding effect, it is proposed to additionally provide the woven fabric as mentioned above with a coating.

Coating of the woven or knitted fabric can take place using usual coating methods, such as spraying it on, applying it using a doctor blade, immersing the fabric in an immersion bath, etc. In this connection, the commercially available dispersions or solutions of the aforementioned conductive polymers can have additional additives added to them, such as wetting agents, thickeners, dispersants, solvents, UV stabilizers, color pigments, flame retardants, cross-linking agents to increase the water resistance and solution resistance of the final coating, etc.

Depending on the conductivity of the coating to be achieved, it is furthermore possible to add other additives that increase conductivity, such as carbon fibers, metal fibers, etc., to the formulation to be applied as a coating.

The formulation to be applied should be adapted to the woven or knitted fabric that is used, and with regard to the conductivity to be achieved, i.e. the ability to shield against radar radiation.

The coated camouflage material produced according to the invention can be used for any desired use, particularly for military purposes, where objects, persons, or animals must be protected against radar recognition. This can involve vehicles, buildings, heavy weapons, or the material can be used as camouflage suits for groups of troops.

Of course, it is advantageous if the camouflage material used is provided with the camouflage patterns or camouflage coloring that is usual and known at present, by means of corresponding coloring or surface texturing, in order to additionally guarantee good camouflage against visual recognition. Furthermore, it is advantageous if the woven or knitted fabric used has a certain optical transparency, on the order of approximately 10 to 40%, preferably 15 to 35%.

Camouflage materials produced according to the invention thus finally demonstrate a conductivity on the order of approximately 300 Ohm/sq to 35 kg Ohm/sq {sic-kg appears to be superfluous here, and the second number (35) appears to be incorrect}.

As already mentioned above, the proposed camouflage material is based on a knitted fabric or an open woven fabric. For shielding in the radar range of 8 to 12 GHz, metal threads, such as those based on constantan or silver, for example, are preferably worked into the textile at intervals of 3 to 5 mm. The effect of these threads is shown in FIGS. 1 and 2. As can particularly be seen in FIG. 2, this arrangement demonstrates little effect at very high frequencies. For this reason, the woven fabric is additionally coated with a conductive material such as one based on polythiophenes, as proposed according to the invention. The effect of this coating is shown in FIGS. 3 and 4. The surface conductivity should amount to approximately 1000 Ohm/sq. The effect of this coating is independent over the frequency, leaving out what is called the skin effect. As described in the article “{in English:} Simple Formulas for estimating the microwave shielding effectiveness of EC-coated optical windows,” Claude A. Klein, SPIE Volume 1112, Window and Dome Technologies and Materials, 234 (1989), for example, the shielding effect decreases greatly in the case of thin layers, with increasing surface resistance, due to the skin effect. For this reason, only a slight effect is achieved with such a layer at 10 GHz, but at 94 GHz, the effect as shown in FIG. 4 is achieved. By combining the installation of thin threads into an open woven or knitted fabric with the application of a coating of conductive materials, it is possible to produce a material that provides optimal shielding against microwaves over a large frequency range. The advantage of this method as compared with the use of a conductive layer having very much lower surface resistance lies in the more sparing use of the very expensive conductive polymers.

### BRIEF DESCRIPTION OF DRAWINGS

As described in the above paragraph, the attached figures show the following:

FIG. 1: Shielding of the reflection of microwave radiation of a metal plate in the range of 8 to 12 GHz by means of parallel wires having a thickness of 1 micron, made of constantan. Distance of wires from one another: 5 mm, distance from the metal plate: 10 cm,

FIG. 2: Shielding of the reflection of microwave radiation of a metal plate in the range of 8 to 94 GHz by means of parallel wires having a thickness of 1 micron, made of constantan. Distance of wires from one another: 5 mm, distance from the metal plate: 10 cm,

FIG. 3: Shielding of the reflection of the microwave radiation at 8 to 12 GHz of a metal plate, by means of a layer having a surface resistance of 1000 Ohms/sq, ignoring the “skin effect.” Distance from the metal plate: 10 cm,

FIG. 4: Shielding of the reflection of the microwave radiation at 89 to 99 GHz of a metal plate, by means of a layer having a surface resistance of 1000 Ohms/sq. Distance from the metal plate: 10 cm.

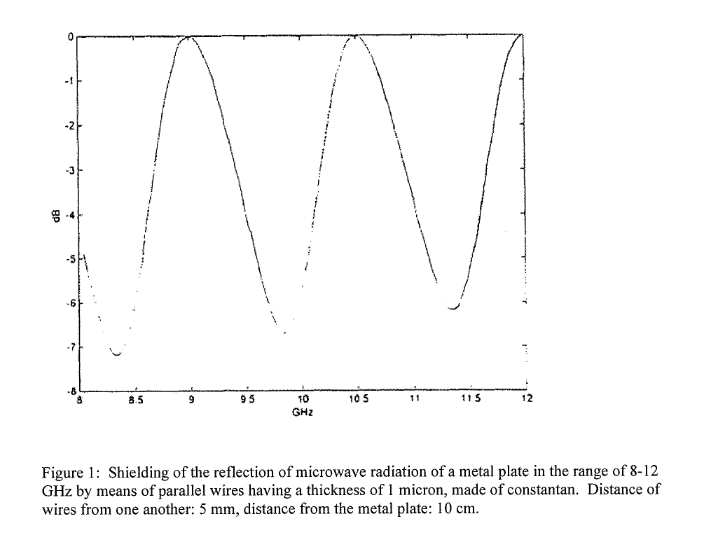

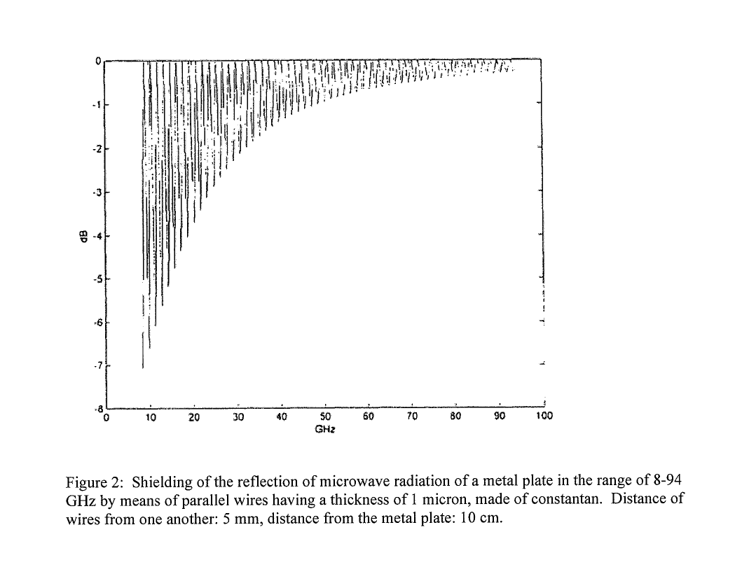

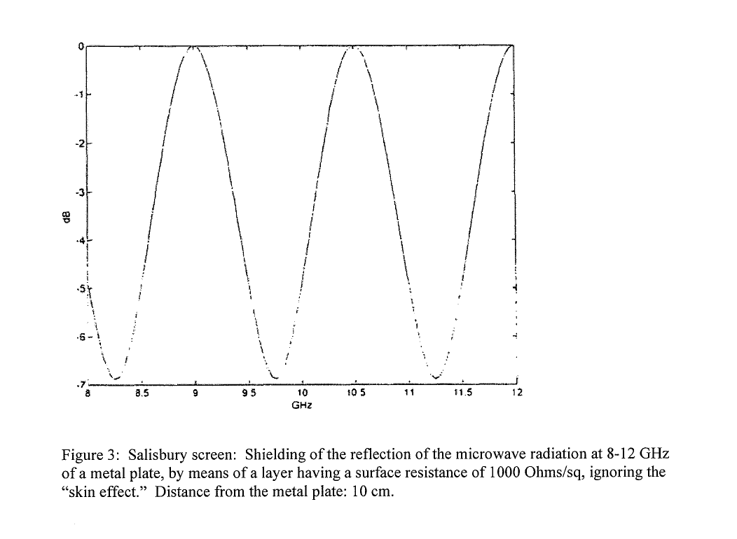

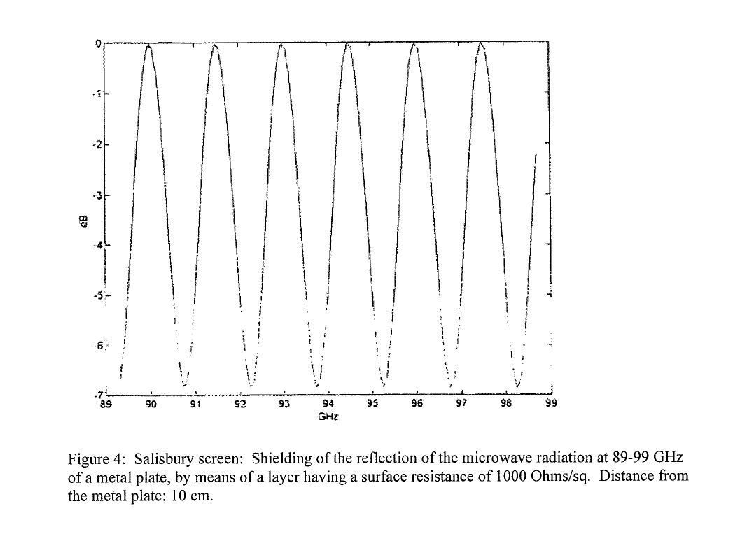

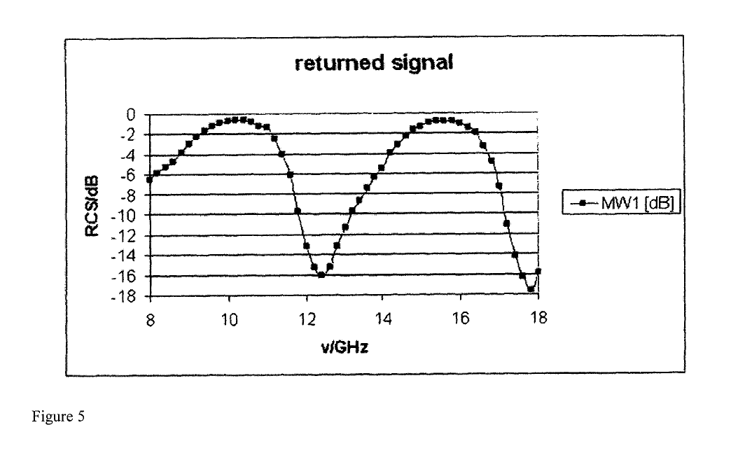

### DETAILED DESCRIPTION

The present invention will be explained in greater detail, using an exemplary embodiment that will be described in the following, as an example.

A camouflage net was used, based on a woven polyester fabric or a woven aramid fabric, having a weight of 120 to 150 g/m².

For the coating, a dispersion from the company Agfa-Gevaert Ltd. with the name Orgacon 5300, i.e. based on polyethylene dioxythiophene (PEDOT), was used.

Before the coating of polyethylene dioxythiophene is applied, the textile is preferably coated with a thin polyurethane coating. This pre-coating closes the surface slightly, and ensures that less PEDOT is absorbed by the textile during the immersion bath described in the following.

Coating of the woven polyester fabric or woven aramid fabric took place by means of immersion coating in a bath based on Orgacon 5300, dissolved or dispersed in the following composition:

| | |
|---|---|
| N-methyl-2-2pyrrolidone | 5-10% |
| Diethylene glycol | 1-5% |
| 2-Heptadecyl benzimidazole-4sulfonic acid | 0.5-1% |

adding:

| | |
|---|---|
| Water | 60-80% |
| Styrene/butyl/acrylate copolymer | 1-5% |
| Polymethyl methacrylate | 1-5% |
| Silica (silicic acid) | 0.5-1% |

Coating takes place in the aforementioned bath, in accordance with generally known, usual immersion coating methods, and the coating process preferably takes place twice, using the immersion method. Using up this solution yields approximately 2×145 ml/m² of woven fabric.

In addition, the following chemicals can be used for the coating:

Urepol (polyurethane)

Ammonia

Flame retardant

Dispersant

and, if necessary, thickener (not absolutely necessary).

The woven polyester fabric saturated or coated with Orgacon in this manner was squeezed out slightly and dried at 160° C. by means of hot air or a heat emitter, for example, for approximately 120 sec; additional cross-linking can take place in the coating by using a cross-linking agent, for example.

For simultaneous flame retardancy, approximately 100 g/l flame retardant (for example cyclic phosphorus compound) and approximately 5 g/l ammonia are required (flame retardancy brings about a clearly softer hand). In this connection, the temperature must be raised to approximately 190-200° C., in order to achieve diffusion of the flame retardant into the polyester fibers.

If a more stable hand is to be achieved, 50-100 g/l polyurethane dispersion and approximately 10 g/l melamine should be used. This addition of polyurethane is also sufficient to support the application or adhesion of pigments, for example.

A slight increase in viscosity brings about better water retention capacity.

Subsequent to the coating process, the efficiency of the camouflage material produced according to the invention against radar radiation was measured, and yielded a reflected radar signal, with reference to a metal plate (0:100% reflection, ˜18 db: 1.6% reflection).

The measurement is shown in the attached FIG. 5, in the diagram shown there.

Fundamentally, it should be explained that coating of the woven or knitted fabric can take place using any known coating method, such as, in particular, an immersion method. In other words, the coating methods, i.e. the immersion methods described, are generally usual methods for coating textile or non-textile woven or knitted fabrics, for example.

The present invention is, of course, by no means restricted to simple woven fabrics such as those usually used for camouflage nets, but rather coating by means of an electrically conductive polymer can be used for any kind of textile or technical woven or knitted fabric, such as also for two-layer, three-dimensional knitted fabrics that are called raschel knitted fabrics. It has been shown, for example, that by using two-ply woven or knitted fabrics, the radar-shielding properties can be increased by means of the interstice formed between the layers.

1. Device for camouflaging objects and persons, comprising a knitted or woven fabric that is provided with a coating, having or containing at least one conductive polymer.

2. Device according to claim 1, wherein the coating is composed on the basis of polythiophene.

3. Device according to claim 1, wherein the woven or knitted fabric is made from a synthetic polymer material.

4. Device according to claim 1, wherein the woven or knitted fabric is made from a polymer material, selected from the group consisting of polyester, polyamide, an aromatic polyamide polypropylene, and a mixture thereof.

5. Device according to claim 1, wherein metal threads are worked into the knitted or woven fabric.

6. Device according to claim 5, wherein the metal threads are worked into the knitted or woven fabric at intervals of approximately 3 to 5 mm in the textile.

7. Device according to claim 5, wherein the metal threads consist of at least one of constantan and silver.

8. Device according to claim 1, wherein a textile used as the knitted or woven fabric has an optical transparency on the order of approximately 10 to 40%.

9. Device according to claim 1, wherein the woven or knitted fabric has at least two plies, where the plies are spaced apart from one another.

10. Method for producing a camouflage device according to claim 1, the method comprising coating a woven or knitted fabric of a synthetic polymer with a formulation on the basis of a conductive polymer of polythiophene by at least one of spraying, using a doctor blade, and an immersion bath.

11. Method according to claim 10, wherein the fabric is a net made of at least one of polyester, polyamide, aramid, and polypropylene, the net being coated in an immersion bath that contains a dispersion of a material selected from he group consisting of polyaniline, polypyrrole, and polythiophene.

12. Method according to claim 11, including adding additives to the immersion bath, which is a dispersion of polyethylene dioxythiophene and at least one of a thickener, a wetting agent, a flame retardant, a color pigment and an electrically conductive filler in the form of a metal powder or fiber.

13. Use of the camouflage device according to claim 1 for camouflaging a military object selected from the group consisting of a vehicle, heavy weapon, building, and as a camouflage suit for a troop or soldier.
